(19) United States
(12) Patent Application Publication
(10) Pub. No.: US 2006/0153943 A1
(43) Pub. Date: Jul. 13, 2006

(54) Mold device for curving sheet member

(76) Inventor: Shwu Ching Lin, Taichung (TW)

Correspondence Address: CHARLES E. BAXLEY, ESQ., 90 JOHN STREET, THIRD FLOOR, NEW YORK, NY, 10038, US

(21) Appl. No.: 11/169,981

(22) Filed: Jun. 28, 2005

(30) Foreign Application Priority Data
Jan. 12, 2005 (TW) 094200625

(51) Int. Cl. B29C 43/02

(52) U.S. Cl. 425/394

(57) ABSTRACT

A mold device for bending a sheet member to form a curved portion, includes a lower mold piece having a mold cavity to rotatably receive a follower which includes a curved recess. An upper mold piece includes an actuating end movable toward the lower mold piece, for forcing the sheet member into the curved recess of the follower, to form the curved portion in the sheet member. The upper mold piece includes an inclined surface formed in one side, and the follower includes an inclined actuator for forcing the sheet member against the inclined surface of the upper mold piece. The lower mold piece includes a spring member for biasing the follower relative to the lower mold piece.

### BACKGROUND OF THE INVENTION

1. Field of the Invention

The present invention relates to a mold device for forming a sheet or planar member, and more particularly to a mold device for curving a sheet or planar member, or for forming a curvature in the sheet or planar member.

2. Description of the Prior Art

Typical sheet or planar members may be bent or folded to various shapes or configurations with mold devices which normally comprise a stationary mold piece, and a movable mold piece movable toward the stationary mold piece, for punching or molding the sheet or planar members into various shapes or configurations or contours.

For example, U.S. Pat. No. 4,076,790 to Lind discloses one of the typical mold devices also comprising a movable mold piece movable toward a stationary mold piece that has a mold cavity formed therein, for partially receiving the movable mold piece, and for forging or molding the sheet or planar members into the required shapes or configurations or contours.

However, for metal or other resilient or spring members, after the punching or forging or molding processes, the resilient or spring members may be slightly sprung backward toward the original position or structure, such that a number of calibrating or checking processes are required to have the resilient or spring members bent or folded to the required shapes or configurations or contours or structures.

In addition, the typical mold devices may not be used to suitably bend or fold the resilient or spring sheet or planar members to the required and curved shapes or configurations or contours or structures.

The present invention has arisen to mitigate and/or obviate the afore-described disadvantages of the conventional mold devices.

### SUMMARY OF THE INVENTION

The primary objective of the present invention is to provide a mold device for suitably forming a curvature or a curved portion in a sheet or planar member.

In accordance with one aspect of the invention, there is provided a mold device for bending a sheet member to form a curved portion therein, the mold device comprising a first mold piece including a mold cavity formed therein, a follower rotatably received in the mold cavity of the first mold piece, and pivotally secured to the first mold piece with a pivot shaft, and including a curved recess formed therein corresponding to the curved portion of the sheet member, and a second mold piece including an actuating end movable toward the first mold piece, for forcing the sheet member into the mold cavity of the first mold piece and into the curved recess of the follower, to form the curved portion in the sheet member. The pivotal attachment of the follower to the first mold piece allows the follower to be rotated relative to the first mold piece, particularly when the sheet member is forced and moved or forged into the mold cavity of the first mold piece and into the curved recess of the follower by the actuating end of the second mold piece.

The second mold piece includes a lower end having an inclined surface formed in one side thereof, and the follower includes an inclined actuator provided therein, for forcing the sheet member toward and against the inclined surface of the second mold piece, to force one planar portion of the sheet member toward the other planar portion, when the actuating end of the second mold piece forces the sheet member into the mold cavity of the first mold piece and into the curved recess of the follower.

The second mold piece includes a notch formed in the first side thereof, for receiving a bent flange of the sheet member. The follower includes an inclined actuator provided therein, for forcing the member toward and against the inclined surface of the second mold piece.

The second mold piece includes a first side having an inclined surface formed therein. The second mold piece further includes a depression formed in the first side thereof, and located above and communicating with the inclined surface thereof.

The first mold piece includes a first mold member and a second mold member secured together. The follower is pivotally secured to the second mold member of the first mold piece with the pivot shaft. The first mold piece includes a spring member engaged therein, and engaged with the follower, for biasing the follower relative to the first mold piece.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded and cross sectional view of a mold device in accordance with the present invention;

FIG. 2 is a perspective view of a planar or sheet member to be bent or folded with the mold device;

FIG. 3 is a partial cross sectional view of the planar or sheet member bent or folded with the mold device;

FIGS. 4, 5, 6 are partial exploded and cross sectional views illustrating the bending operation of the planar or sheet member bent or folded with the other mold device;

FIG. 7 is a partial exploded and cross sectional view similar to FIG. 1, illustrating the operation of the mold device;

FIG. 8 is an enlarged partial cross sectional view of the mold device;

FIG. 9 is a further enlarged partial cross sectional view illustrating an upper or movable mold piece of the mold device; and

FIG. 10 is an enlarged partial cross sectional view of the planar or sheet member bent or folded with the mold device.

### DETAILED DESCRIPTION OF THE PREFERRED EMBODIMENT

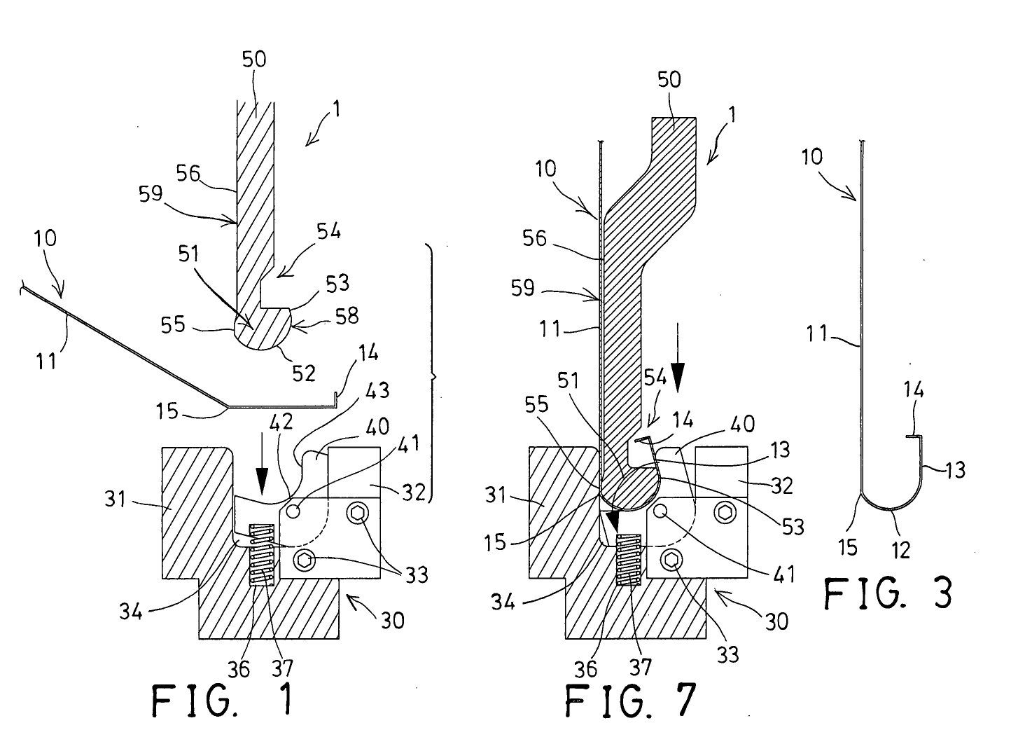

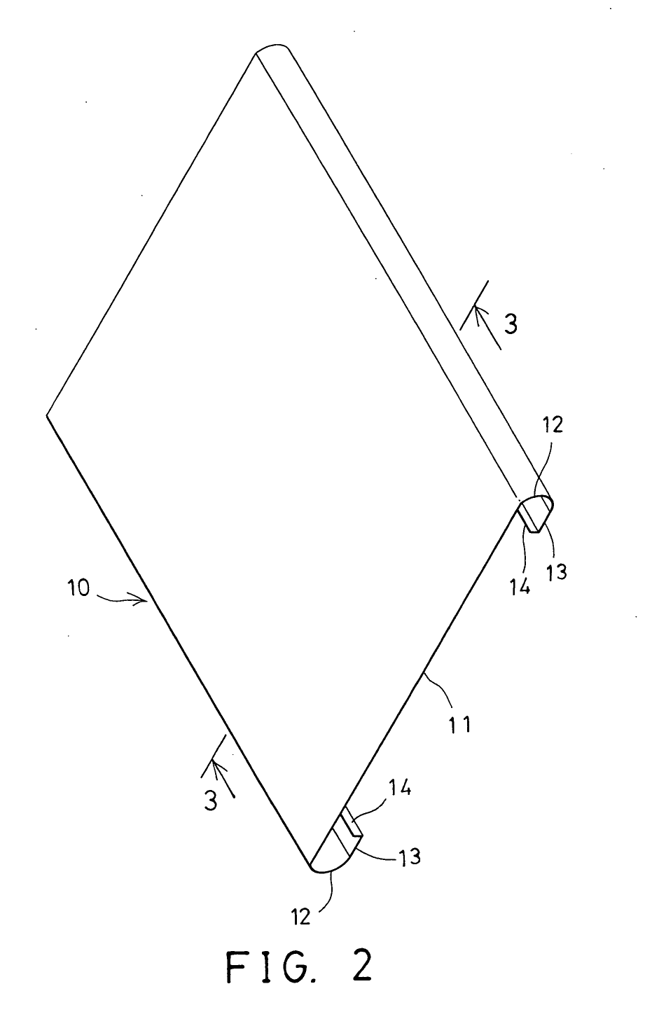

Referring to the drawings, and initially to FIGS. 1-3, a mold device 1 in accordance with the present invention is provided for folding or bending a planar or sheet member 10 to form a curved portion 12 therein. For example, the planar or sheet member 10 may include a longer or first planar portion 11, and a shorter or second planar portion 13 having the curved portion 12 disposed or arranged therebetween, and may further include a bent segment or flange 14 bent from the shorter planar portion 13 and preferably perpendicular to the shorter planar portion 13. A bending line 15 may preferably be formed or provided between the curved portion 12 and the longer planar portion 11.

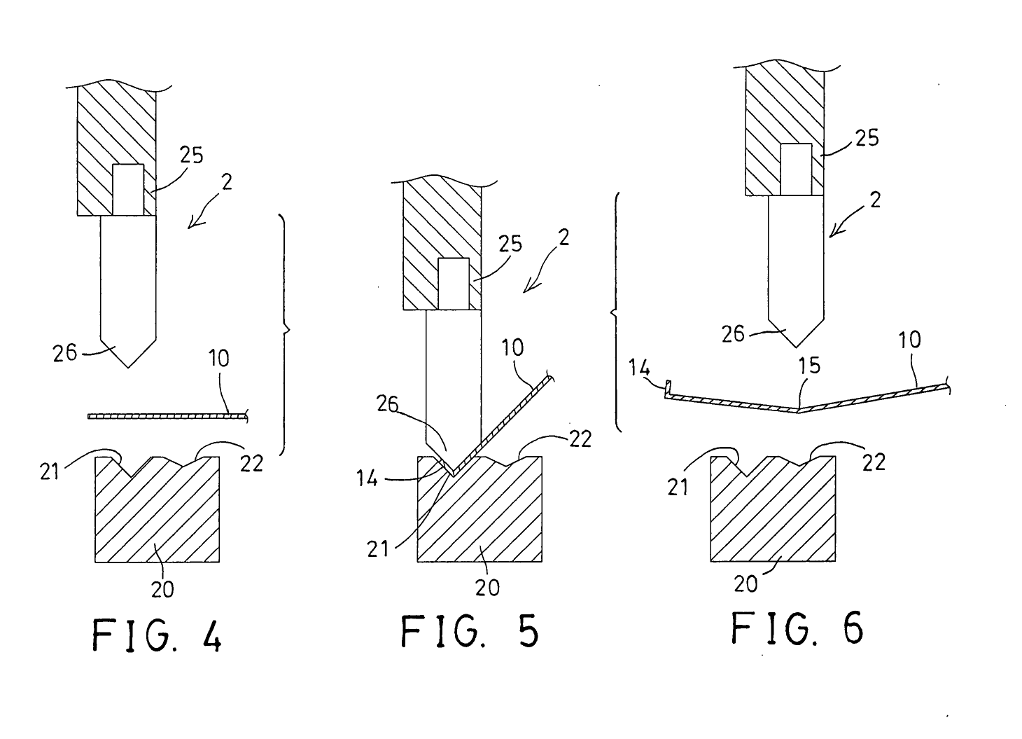

As shown in FIGS. 4-6, before folding or bending the planar or sheet member 10 to form the curved portion 12 in the planar or sheet member 10, the planar or sheet member 10 may first be disposed in another mold device 2, such as disposed between a lower stationary mold piece 20 and an upper movable mold piece 25, and the lower stationary mold piece 20 may include one or more mold cavities 21, 22 formed therein, and the upper movable mold piece 25 may include a mold element 26 movable toward the mold cavities 21, 22 of the lower stationary mold piece 20, for bending or forming the bent segment or flange 14 and/or the bending line 15 in the planar or sheet member 10, for example.

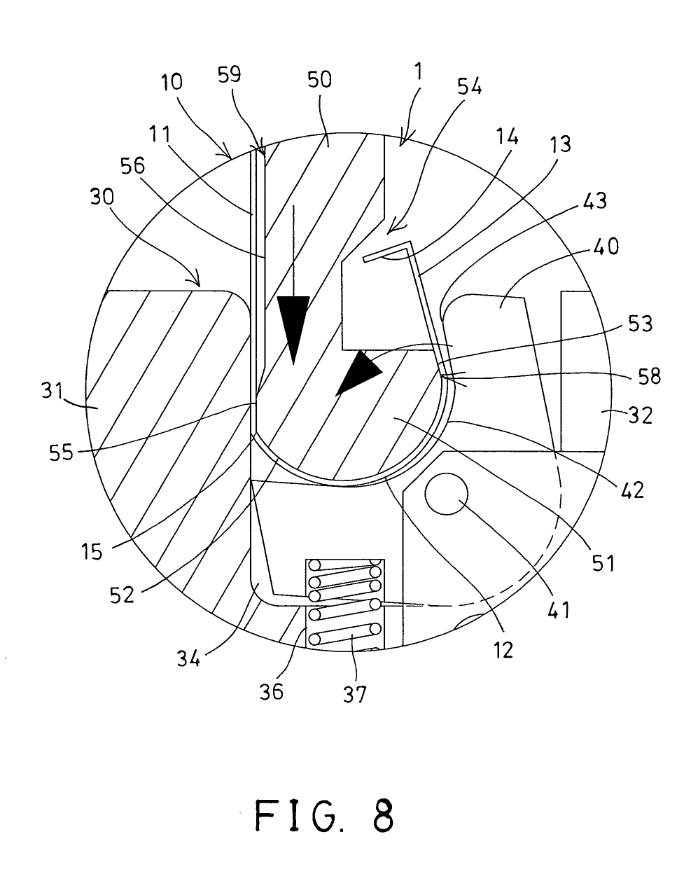

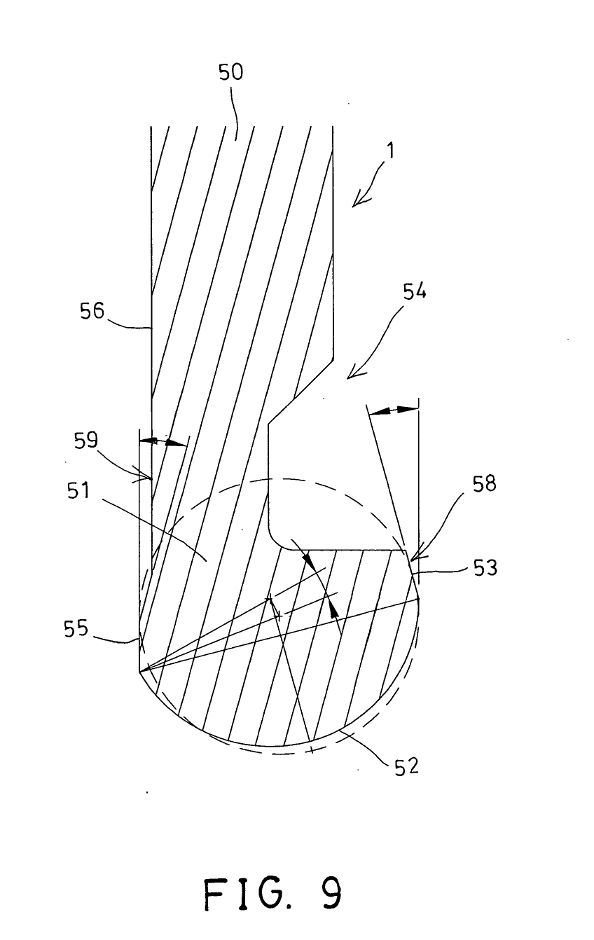

As shown in FIGS. 1 and 7-8, the mold device 1 in accordance with the present invention also comprises a lower or stationary or first mold piece 30 and an upper or movable or second mold piece 50 that is also movable toward the lower or second mold piece 50, for bending or forming the curved portion 12 in the planar or sheet member 10. The lower mold piece 30 may include one or more, such as two mold members 31, 32 secured together with such as fasteners 33, and may include a mold cavity 34 formed therein, such as formed in both of the mold members 31, 32, for rotatably or pivotally or hingely receiving a follower 40 therein.

For example, the follower 40 is rotatably or pivotally attached or secured to the lower mold piece 30, such as secured to the mold member 32 of the lower mold piece 30 with a pivot shaft 41, to allow the follower 40 to be rotated relative to the lower mold piece 30 for a limited angle, best shown in FIGS. 1 and 7-8, between an open or rest or first position (FIG. 1) and a closing or acting or working or second position (FIG. 7). The follower 40 includes a curved recess 42 formed therein, and having a curvature similar to or identical to or corresponding to that of the curved portion 12 to be formed in the planar or sheet member 10.

The lower mold piece 30 may include an orifice 36 formed therein, such as formed in one of the mold members 31, for receiving a spring member 37 therein. The spring member 37 is engaged between the mold member 31 of the lower mold piece 30 and the follower 40, for biasing or moving the follower 40 toward the open or rest position as shown in FIG. 1, where the curved recess 42 of the follower 40 is opened upwardly. The follower 40 may also be rotated or moved relative to the lower mold piece 30, against the spring member 37, toward the closing or working position as shown in FIG. 7.

The upper mold piece 50 includes a lower or actuating end 51 movable downwardly for engaging with the planar or sheet member 10, and for forcing or forging the planar or sheet member 10 into the mold cavity 34 of the lower mold piece 30 and into the curved recess 42 of the follower 40, and thus for forming the curved portion 12 in the planar or sheet member 10. The upper mold piece 50 further includes a cut off portion or an inclined surface 53 formed in one side 58 of the lower end 51 thereof, and the follower 40 includes a corresponding inclined actuator 43 provided or formed therein, for forcing the planar or sheet member 10 toward and against the inclined surface 53 of the upper mold piece 50, best shown in FIG. 7.

For example, as best shown in FIGS. 7-8 and 10, when the lower end 51 of the upper mold piece 50 is moved downwardly to force the planar or sheet member 10 into the curved recess 42 of the follower 40 and to rotate the follower 40 relative to the lower mold piece 30 against the spring member 37, the inclined actuator 43 of the follower 40 may force the second planar portion 13 of the planar or sheet member 10 toward and against the inclined surface 53 of the upper mold piece 50, to slightly bend and incline the second planar portion 13 relative to and toward the first planar portion 11 of the planar or sheet member 10.

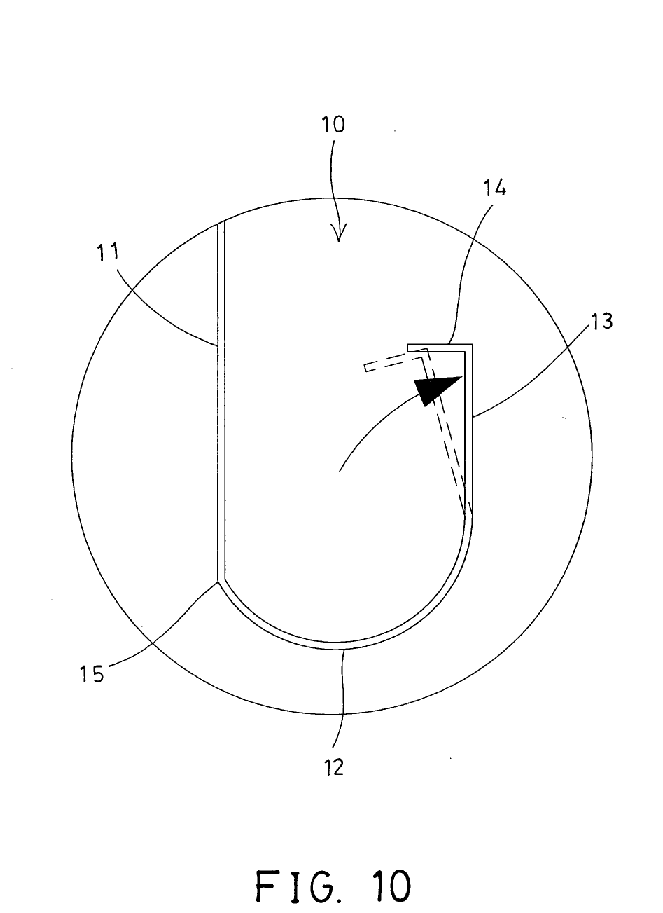

As shown in FIG. 10, after the upper mold piece 50 and the planar or sheet member 10 are moved away from the lower mold piece 30 and the follower 40, the second planar portion 13 is allowed to be sprung back and moved away from the first planar portion 11 of the planar or sheet member 10 toward a position where the second planar portion 13 is substantially parallel to the first planar portion 11 of the planar or sheet member 10. The upper mold piece 50 may include a notch 54 formed therein, for receiving the bent segment or flange 14 of the planar or sheet member 10, and thus for allowing the second planar portion 13 to be bent and inclined relative to and toward the first planar portion 11 of the planar or sheet member 10.

It is further preferable that the upper mold piece. 50 further includes a cut off portion or an inclined surface 55 formed in the other side 59 of the lower end 51 thereof, and opposite to the one side 58 of the inclined surface 53, and may further include a further cut off portion or a depression 56 formed in the other side of the lower end 51 thereof, and located above and communicating with the inclined surface 55 thereof, for allowing the lower end 51 of the upper mold piece 50 to be smoothly engaged into the mold cavity 34 of the lower mold piece 30 and the curved recess 42 of the follower 40.

In operation, as shown in FIGS. 4-6, the mold element 26 of the upper movable mold piece 25 of the mold device 2 may first be moved downwardly toward the lower stationary mold piece 20, to bend or form the bent segment or flange 14 and/or the bending line 15 in the planar or sheet member 10. The planar or sheet member 10 may then be forced into the curved recess 42 of the follower 40 by the lower end 51 of the upper mold piece 50 which may also rotate the follower 40 relative to the lower mold piece 30 against the spring member 37, in order to form the curved portion 12 in the planar or sheet member 10.

The arrangement or the provision of the cut off portion or the inclined surface 53 in the one side 58 of the lower end 51 of the upper mold piece 50 allows the second planar portion 13 of the planar or sheet member 10 to be forced toward and against the inclined surface 53 of the upper mold piece 50, and to be slightly bent and inclined relative to and toward the first planar portion 11 of the planar or sheet member 10, and allows the second planar portion 13 to be sprung back and moved away from the first planar portion 11 of the planar or sheet member 10 toward a position where the second planar portion 13 is substantially parallel to the first planar portion 11 of the planar or sheet member 10 after the upper mold piece 50 and the planar or sheet member 10 are moved away from the lower mold piece 30 and the follower 40.

Accordingly, the mold device in accordance with the present invention may be provided for suitably forming a curvature or a curved portion in a sheet or planar member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mold device for bending a sheet member to form a curved portion therein, said mold device comprising:
a first mold piece including a mold cavity formed therein,
a follower rotatably received in said mold cavity of said first mold piece, and pivotally secured to said first mold piece with a pivot shaft, and including a curved recess formed therein corresponding to the curved portion of the sheet member, and
a second mold piece including an actuating end movable toward said first mold piece, for forcing the sheet member into said mold cavity of said first mold piece and into said curved recess of said follower, to form the curved portion in the sheet member.

2. The mold device as claimed in claim 1, wherein said second mold piece includes a lower end having an inclined surface formed in one side thereof, and said follower includes an inclined actuator provided therein, for forcing the sheet member toward and against said inclined surface of said second mold piece when said actuating end of said second mold piece forces the sheet member into said mold cavity of said first mold piece and into said curved recess of said follower.

3. The mold device as claimed in claim 2, wherein said second mold piece includes a notch formed in said first side thereof, for receiving a bent flange of the sheet member.

4. The mold device as claimed in claim 2, wherein said follower includes an inclined actuator provided therein, for forcing the member toward and against said inclined surface of said second mold piece.

5. The mold device as claimed in claim 1, wherein said second mold piece includes a first side having an inclined surface formed therein.

6. The mold device as claimed in claim 5, wherein said second mold piece further includes a depression formed in said first side thereof, and located above and communicating with said inclined surface thereof.

7. The mold device as claimed in claim 1, wherein said first mold piece includes a first mold member and a second mold member secured together.

8. The mold device as claimed in claim 7, wherein said follower is pivotally secured to said second mold member of said first mold piece with said pivot shaft.

9. The mold device as claimed in claim 1, wherein said first mold piece includes a spring member engaged therein, and engaged with said follower, for biasing said follower relative to said first mold piece.
